(19) United States
(12) Patent Application Publication
(10) Pub. No.: US 2017/0039093 A1
(43) Pub. Date: Feb. 9, 2017

(54) CORE LOAD KNOWLEDGE FOR ELASTIC LOAD BALANCING OF THREADS

(71) Applicant: Futurewei Technologies, Inc., Plano, TX (US)

(72) Inventors: Zongfang Lin, Santa Clara, CA (US); Chen Tian, Santa Clara, CA (US); Feng Ye, Santa Clara, CA (US); Jiachen Xue, Santa Clara, CA (US); Ziang Hu, Santa Clara, CA (US)

(21) Appl. No.: 14/818,253

(22) Filed: Aug. 4, 2015

(51) Int. Cl. G06F 9/50; G06F 9/48

(52) U.S. Cl. CPC G06F 9/5083; G06F 9/4881

(57) ABSTRACT

A method of balancing load on multiple cores includes maintaining multiple bitmaps in a global memory location. Each bitmap indicates loads of the threads included in a thread domain. The multiple threads are associated with each core. Each core maintains and updates the respective bitmap based on the loads of the threads. The multiple bitmaps are maintained in the global memory location which is accessible by a multiple thread domains configured to execute threads using the cores. Execution of the multiple thread domains is balanced using the multiple cores based on loads of each thread described in each bitmap.

### BACKGROUND

As the computer industry moves toward large-scale multicore processors (sometimes called Chip Multiprocessor (CMP)), a quantity of cores on a central processing unit (CPU) chip increases. Many such CPUs are soldered together using fast interconnects to form a non-uniform memory access (NUMA) machine. Consequently, modern computer servers are equipped with a large quantity of physical cores. When multiple clients make requests directed to a particular resource, one or more cores execute the requests. Multiple requests can be queued and serviced one at a time or in batches by one or more cores causing some requests to sit in the queue until an earlier request or batch of requests have been serviced. However, some physical cores may be executing relatively fewer requests compared to some other physical cores. Load balancing refers to the transfer of service requests in the queue to those physical cores that are relatively less loaded compared to those physical cores that are more loaded. Load balancing is important to tune the performance of multiple cores.

### SUMMARY

This specification describes elastic load balancing of threads. In some implementations, elastic load balancing of threads can be implemented using dynamic knowledge of load in each processor core.

Certain implementations of the subject matter described in this specification can be implemented as a method of balancing load on multiple thread execution cores. Each bitmap indicates loads of multiple threads included in a thread domain. The multiple threads are associated with each thread execution core. Each thread execution core maintains and updates the respective bitmap based on the loads of the multiple threads. The multiple bitmaps are maintained in a global memory location which is accessible by multiple thread domains configured to execute threads using the multiple thread execution cores. Execution of the multiple thread domains is balanced using the multiple thread execution cores based on loads of each of the multiple threads described in each bitmap of the multiple bitmaps.

Certain implementations of the subject matter described here can be implemented as a thread execution core to self-balance load. The thread execution core is configured to perform operations described here. Certain implementations of the subject matter described here can be implemented as a system to balance load on multiple thread execution cores. The system includes a global memory location accessible by multiple thread domains configured to execute threads using the multiple thread execution cores. Each thread execution core is coupled to the global memory location and is configured to perform operations described here.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example of a machine with multiple thread execution cores.

FIG. 2 is a schematic diagram of a bitmap table including bitmaps maintained by multiple thread execution cores.

FIG. 3 is a schematic diagram of a bitmap maintained by a thread execution core indicating that the core is idle.

FIG. 4 is a schematic diagram of a bitmap maintained by a thread execution core indicating that the core is busy.

FIG. 5 is a flowchart of an example of a process for elastically load balancing threads executable on the machine of FIG. 1.

### DETAILED DESCRIPTION

This specification describes techniques to elastically balance loads of threads across processes and thread execution cores in a machine at a user level. Thread execution core is a core on which one or a plurality of threads can be executed. As described below, each thread execution core (“core”) can include a shared bitmap to provide global knowledge describing an availability of the core to execute threads including, for example, if the core is busy or idle and if the core has been pre-assigned to a thread domain. If the thread domain has been pre-assigned to the core, then the thread domain is a host domain for that core; if the thread domain has not been pre-assigned to the core, then the thread domain is a guest domain for that core. If the core is idle, then other threads can utilize the idle core for execution. If any thread from the thread domain to which the core has been pre-assigned needs to be executed, the thread utilizing the core can return the core to a thread from the host domain after continuing execution for a period of time. After such execution for the period of time, the thread will return the core to the host domain thread.

The load balancing approach described in this specification can be implemented to allow any thread to have dynamic knowledge of load on each core on a machine. The thread can be from any process or any core. The data structure for maintaining load on each core can be implemented in a simple and low cost manner. The hybrid scheduling can allow elastic timing of load migration with flexible ways of core allocation (for example, donation or sharing, described later). Implementations of the techniques described here can allow host domains (described later) to take precedence in utilizing core resources pre-assigned to the host domains over guest domains that have not been pre-assigned to the core. The techniques are busy-driven with balancing occurring as needed.

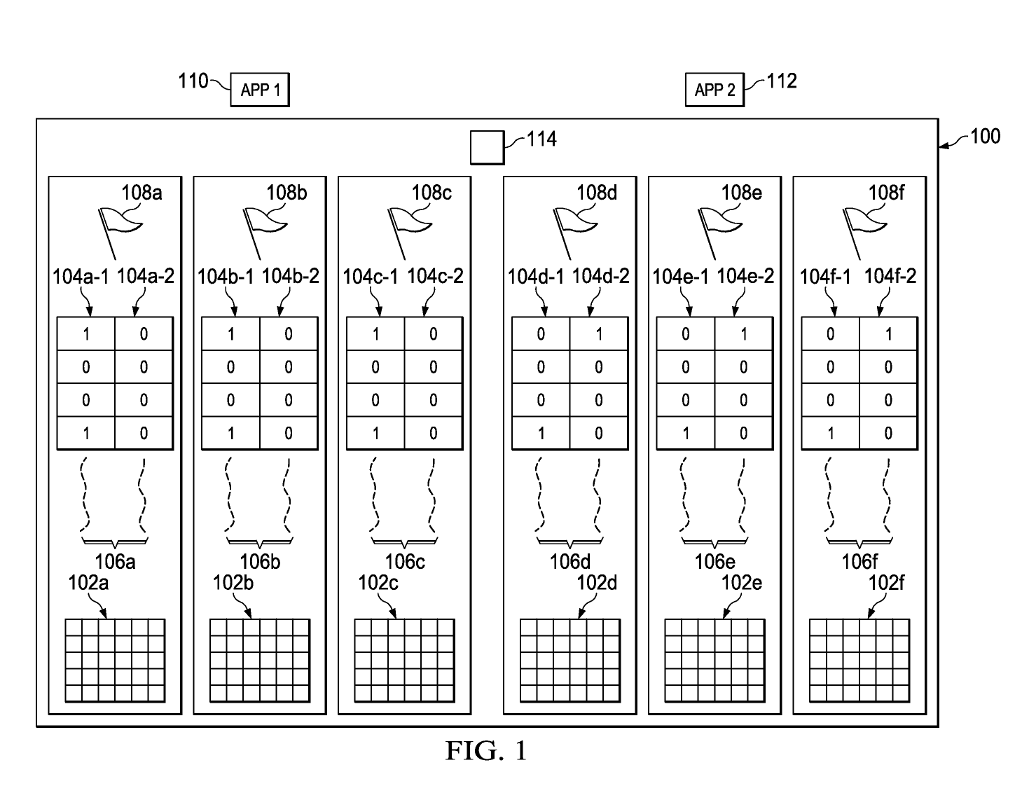

FIG. 1 is a schematic diagram of an example of a machine 100 with multiple thread execution cores (for example, thread execution cores 102a, 102b, 102c, 102d, 102e, 102f, or more or fewer cores). The machine 100 can execute multiple applications (for example, a first application 110, a second application 112, or more applications) with the multiple cores. One or more cores are assigned to each application. For example, cores 102a, 102b and 102c are pre-assigned to the first application 110, and cores 102d, 102e and 102f are pre-assigned to the second application 112. Other cores (not shown) can be assigned to other applications (not shown). The cores can be assigned to the applications by setting CPU affinity and bypass user-defined scheduling.

Each application executing on the machine 100 can be implemented as computer instructions stored on a computer-readable medium and executable to perform operations in response to input. One or more or all of the applications can have low latency and may need to meet tight deadlines. In this sense, one or more or all of the applications can be executable in real-time. An application acts in real-time when there is an imperceptible delay (for example, of the order of milliseconds or less) between an output processed in response to receiving an input.

In addition, each application can include or be associated with one or more threads, each of which is an execution unit on a core. Each core to which an application is assigned can execute (or process) one or more threads included in or associated with the application. For example, the first application 110 includes or is associated with threads 106a, 106b and 106c, which are executed on cores 102a, 102b and 102c, respectively. Similarly, the second application 110 includes or is associated with threads 106d, 106e and 106f, which are executed on cores 102d, 102e and 102f, respectively. In alternative implementations, the first application 110 includes or is associated with threads 106a-1, 106b-1 106c-1, 106d-1, 106e-1, and 106f-1 which are executed on cores 102a, 102b 102c, 102d, 102e, and 102f, respectively. Similarly, the second application 112 includes or is associated with threads 106a-2, 106b-2 106c-2, 106d-2, 106e-2 and 106f-2, which are executed on cores 102a, 102b 102c, 102d, 102e and 102f, respectively. In this situation, cores 102a, 102b, and 102c are pre-assigned to 106a-1 106b-1, 106c-1, respectively; cores 102d, 102e, and 102f are pre-assigned to 106d-2 106e-2, 106f-2, respectively. In some implementations, a core can execute one thread or more than two threads included in or associated with an application to which the core has been assigned.

Each application executing on the machine 100 runs as an independent process. That is, threads from one application have limited or no knowledge about other threads, particularly, about loads on the other threads. During a certain period of time, some applications can have heavy loads while other applications have comparatively less loads resulting in loads being unbalanced.

Each core in the machine 100 can contribute to elastic load balancing by implementing the techniques described in this specification. Each core can maintain a bitmap that includes information describing loads of threads executable by the core with other cores in the machine. For example, cores 102a, 102b, 102c, 102d, 102e and 102f can maintain bitmaps 104a, 104b, 104c, 104d, 104e and 104f, respectively. A core's bitmap can include one or more columns. For example, the bitmaps 104a, 104b, 104c, 104d, 104e and 104f can each have two (or more) columns, 104a-1 and 104a-2, 104b-1 and 104b-2, 104c-1 and 104c-2, 104d-1 and 104d-2, 104e-1 and 104e-2 and 104f-1 and 104f-2, respectively. For example, the bitmap of a core that executes one application can include one column. In another example, the bitmap of a core that executes multiple applications can include more than one column. A core's bitmap can also include additional columns that do not correspond to any application. Such columns are spare columns available to other applications. A core can maintain a bitmap by storing the bitmap locally (that is, at a location accessible only to the core) and by periodically updating entries in the bitmap to reflect loads of threads executable by the core. The bitmap of each core can have a size intended to avoid false sharing of the cache. For example, the bitmap can have a size of 64 bytes.

In addition, each core can make the bitmap available to a global memory location (for example, memory 114 in machine 100). To do so, each core can map the bitmap to a region in the global map so that other applications can access the information. For example, each core can implement mmap functions to map each core's bitmap to the global memory location. In such implementations, the mmap function establishes a mapping between an address space and a file or shared memory object. There are some alternative ways to implement functionality of mapping or maintaining, besides mmap. In addition, any change to a bitmap can automatically be reflected in the global memory location. In some implementations, operating system (OS) running on each core can map (or maintain) the bitmap on the core to a bitmap table in the global memory location.

In some implementations, the global memory location can maintain a bitmap table which includes the bitmaps mapped from all the cores. The global memory location can make the bitmap table be accessible to all other cores in the machine such that, at any given time, a thread executable on a core can obtain information describing loads of threads executable on other cores by accessing bitmaps of the other cores available at the global memory location.

The threads 106a included in the first application 110 can be executed on the cores. For example, the threads 106a can be executed in response to an input received by the first application 110 to perform computer operations, and the threads 106a can access the memory 114 in machine 100 to scan the bitmaps mapped from cores 102a, 102b, 102c, 102d, 102e and 102f. In some implementations, the threads 106a can access the memory 114 in machine 100 to scan the bitmaps mapped from other cores 102b, 102c, 102d, 102e and 102f. In implementations in which threads are not pre-assigned to cores, the threads 106a can be executed based on an availability of a core as determined from the core's bitmap. For example, by scanning the bitmap table, the threads 106a can determine that the core 102c is idle while remaining cores are busy. In response, the threads 106a can request resource from the idle core 102c based on allocation decisions. In response to being allocated the requested resource, the threads 106a can execute on the idle core 102c.

In some implementations, threads can be pre-assigned to cores. For example, threads 106d included in the second application 112 can be pre-assigned to the core 102d. When threads are pre-assigned to a core, then the pre-assigned threads have greater precedence for execution on the core compared to other threads that have not been pre-assigned to the core. In such implementations, the threads 106d can scan the bitmap table to determine if any core has been pre-assigned to the thread. In response to determining that the core 102d has been pre-assigned to the threads 106d, execution of other threads on the core 102d can be terminated. As described below, the termination of the other threads need not be immediate, but can occur after a period of time during which the execution of the threads can reach a logical break point.

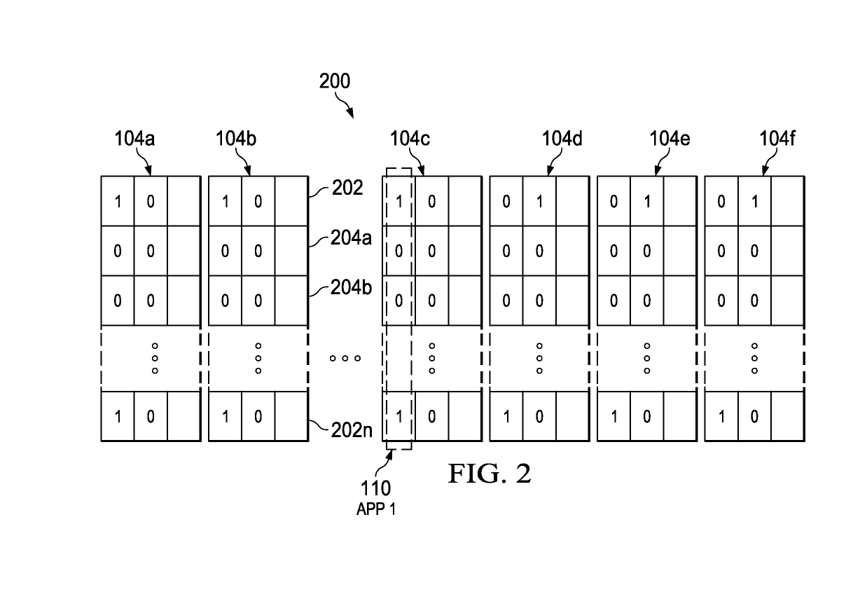

FIG. 2 is a schematic diagram of a bitmap table 200 including bitmaps maintained by multiple thread execution cores. For example, the bitmap table 200 can include bitmaps 104a, 104b, 104c, 104d, 104e and 104f mapped from the cores 102a, 102b, 102c, 102d, 102e and 102f, respectively. The bitmap table 200 can be maintained in, for example, stored in or accessible by, a global memory location, for example, memory 114. A cell in a bitmap can include entries that can be set by the core from which the bitmap was mapped. Alternatively or in addition, each cell in each bitmap can include entries that can be set by a controller connected to all the cores in the machine.

A width of the bitmap table can be adjusted based on a number of applications executing on the machine. Entries in a bitmap can be set and modified as described below. Notably, entries in a bitmap can be set only by the core that maintains the bitmap. The entries can be read by threads executing on other cores or awaiting execution. Elastic load balancing or self-balancing can be implemented by referencing the entries in the bitmap table 200.

The bitmap table 200 includes multiple rows (for example, rows 204a, 204b . . . 204n) and columns. Each column in the bitmap table 200 corresponds to a column of a bitmap mapped from a core (for example, columns of bitmaps 104a, 104b, 104c, 104d, 104e, 104f). As described above, each bitmap mapped from each core can include one or more columns assigned to applications or spare columns unassigned to any application (or both). A column can indicate an application that includes or is associated with a thread domain. For example, a column in the bitmap table 200 corresponds to the bitmap 104c maintained and updated by the core 102c. The column indicates the first application 110 meaning that part or all of threads 106c included in or associated with the first application 110 are executing on the core 102c. The thread domain includes one or more threads executable on a core. The multiple rows in the bitmap table 200 can indicate the threads in the thread domain. That is, each cell in a row other than the first row of a bitmap can indicate a respective thread in the thread domain.

The entries in the bitmap table 200 can collectively describe the availabilities of the bitmap table 200 for thread execution. For example, the entries in a column that represents a bitmap (for example, bitmap 104a) can describe if the core that maintains the bitmap 104a is available for thread execution, if the core has been pre-assigned to one or more threads of an application or if an availability of the core for thread execution has changed (that is, from available to busy or from busy to available).

As described above, each column in the bitmap table 200 is a column included in a bitmap that indicates an application that includes or is associated with a thread domain. In some implementations, the first row 202 in each column in the bitmap table 200 can indicate if the thread domain has been pre-assigned to the core that maintains the bitmap table 200. If the thread domain has been pre-assigned to the core, then the thread domain is the host domain for that core. All other thread domains are guest domains for that core. As described above, threads in the host domain take precedence (that is, are given priority) over other threads in guest domains for access to the resource of the core to which the host domain has been pre-assigned.

For example, a value stored in the first cell in a column is set to 1 when a thread domain has been pre-assigned to the core or set to 0 when no thread domain has been pre-assigned to the core. In the bitmap table 200, the entry in the first row of the first column of each of bitmap 104a, bitmap 104b, and bitmap 104c is 1 indicating that thread domains of the application indicated by these columns have been pre-assigned to the respective cores that maintain the corresponding bitmaps. In the bitmap table 200, the entry in the first row of the second column of each of bitmap 104d, bitmap 104e and bitmap 104f is 0 indicating that no thread domains have been pre-assigned to the cores that maintain the corresponding bitmaps.

Also as described above, the multiple rows other than the first row in each bitmap can indicate the threads in the thread domain. A value stored in the row is set to 1 if the thread is busy or is set to 0 if the thread is available. In the bitmap table 200, the entry in the fourth row of the first column of the bitmap 104a is 1 indicating that the thread indicated by the third row of the first column is busy. In another example, the entry in the second row of the second column of the bitmap 104b is 0 indicating that the thread indicated by the second row of the second column is idle.

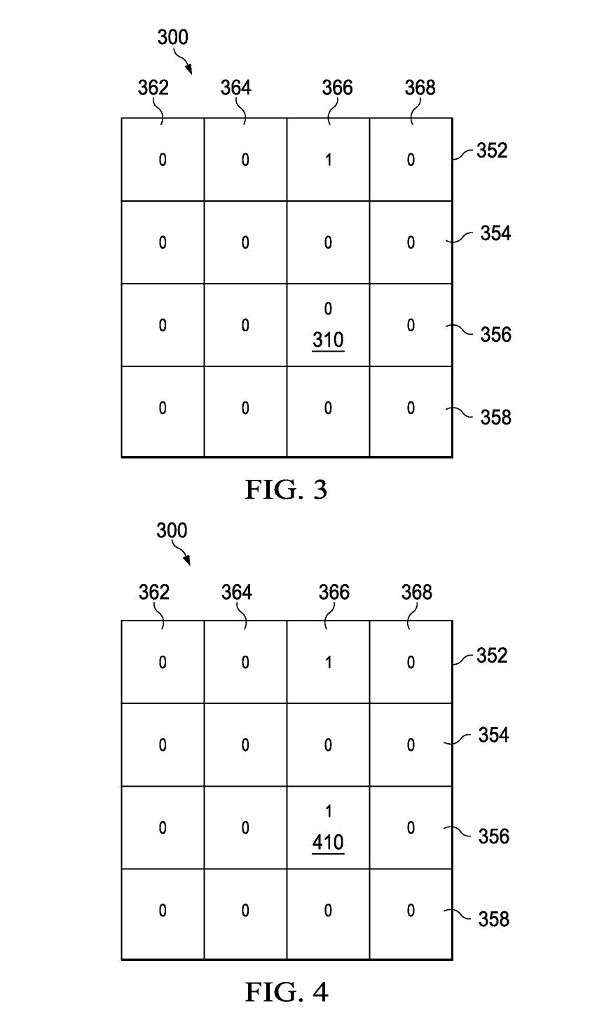

FIG. 3 is a schematic diagram of a bitmap maintained by a thread execution core indicating that the core is idle. The first row in the bitmap 300 indicates host domains, if any. For example, the bit entry of 1 in the intersection of row 352 and column 366 in the bitmap 300 indicates that the core that maintains the bitmap 300 has been pre-assigned a host domain. The bit entry of 0 in the remaining cells of the first row indicates that no host domain has been assigned. As described above, each cell in rows other than the first row in each column indicate an availability of threads executable on the core that maintains the bitmap 300. A core is idle if all threads in the core are idle. In other words, the core is idle if each entry in each row except the first row in a column is 0. To determine if a core is idle, a Boolean OR operation can be performed on the entries set in each row (except the first row) of a column. Such an operation on the columns of the bitmap 300 reveals that the core that maintains the bitmap 300 is idle.

When an idle core becomes busy, the core updates the corresponding entry in the core's bitmap from 0 to 1. A thread is busy if the thread has a long queue of jobs to be handled, if the thread has a big job to do, or some jobs to be handled by the thread might miss or have missed a deadline (or combinations of them). Threads either awaiting execution or executing on other cores can scan the bitmap table to identify the core for which the availability status was updated from 0 (idle) to 1 (busy). More specifically, a thread need not always scan the bitmap table to determine the status of a core. Instead, the thread can scan the bitmap table to identify an available core only when the load on the thread is heavier than a threshold load or when the thread needs additional resources to execute operations or perform functions. In such situations, the threads can determine that the resources of the busy core are unavailable for execution until the core becomes idle again and the corresponding bitmap entry is updated to 0. In this manner, the criteria for a thread scanning the bitmap table can be busy-driven.

FIG. 4 is a schematic diagram of a bitmap 300 maintained by the thread execution core indicating that the core is busy. The bitmap 300 in FIG. 4 is substantially identical to the bitmap 300 in FIG. 3, except that the cell 310 in FIG. 3, which includes the entry “0”, has been modified into the cell 410 in FIG. 4, which includes the entry “1”. As described above, a core is idle if all threads in the core are idle. When a thread performs a Boolean OR operation on the entries in the rows of the bitmap 300 except the first row, the result will be 1 indicating that the core corresponding to the bitmap 300 is busy. Furthermore, if the thread performs a Boolean AND operation on a result of the Boolean OR operation and the first row, the result will be 1 not only indicating that the core is busy but also indicating that the core is busily executing the threads from the core's pre-assigned application, i.e., the host domain.

When a busy core becomes idle, the core updates the corresponding entry in the core's bitmap from 1 to 0. The core also broadcasts the update to the global memory location causing a corresponding update in the bitmap table. Busy threads can scan the bitmap table to identify the core for which the availability status was updated from 1 (busy) to 0 (idle). One or more of the threads can then use the idle core's resources for execution, which, in turn, can cause the bitmap entry to be updated from 0 (idle) to 1 (busy).

In instances in which a thread included in a thread domain and executing on a first core determines that a second core has recently become available, the entirety of the execution of the thread need not be transferred from the first core to the second core. Instead, a sleeping thread from the same application can be activated from the second core and a portion of workload from the busy thread can be transferred to the newly activated thread leaving a remainder of the execution with the first core. In this manner, the same application can be executed simultaneously on two or more cores. A sleeping thread (or a helper thread) is a thread which sleeps (i.e., is idle) until activated. The sleeping thread can be activated when the corresponding application of the sleeping thread gains the execution opportunity from the core. As such, the helper thread has no load until it is activated.

In some implementations, the availability status of a core to execute threads can be determined based on whether the core has been pre-assigned a thread domain, i.e., whether the core has a host domain. As described above, a value stored in the first cell in a column is set to 1 when a thread domain has been pre-assigned to the core or set to 0 when no thread domain has been pre-assigned to the core. A guest domain (i.e., a thread domain that has not been pre-assigned to a core) can execute on the core if the threads in the core are available and the host domain does not need execution.

For example, a running thread from a guest domain executing on a core can periodically check if threads in the core's host domain are busy. If the guest domain determines that the threads in the core's host domain are idle, then the guest domain can continue executing on the core. Alternatively, if the guest domain determines that the threads in the host domain are busy, then the guest domain can return the pre-assigned core to the host domain. The guest domain can determine that the host domain is busy if one or more threads in the host domain are in a queue or are executing on one or more cores other than the host domain's pre-assigned core. In response, the guest domain can continue executing for a period of time, then cease executing on the host domain's pre-assigned core, thereby returning the pre-assigned core to the host domain. The period of time for which the guest domain continues to execute can depend on factors including the latency and deadline of a job. The period of time can also depend on whether the guest domain has reached a logical break point in the execution, for example, a point at which execution can be transferred to a different core and re-started without incurring any losses or delays.

Returning to FIG. 1, in some implementations, a core in the machine 100 that has been pre-assigned a thread domain can maintain a flag (for example, flags 108a, 108b, 108c, 108d, 108e, 108f and more or fewer flags) that indicate a decision by the core to either donate its resources to or share its resources with other threads. The decision to donate or share can be made by the application that includes or is associated with the host domain. If the application determines to donate the pre-assigned core's resources, then the application can mark the decision flag and yield the core's resources (either partially or entirely) to busy threads in other thread domains. In such instances, the current active threads of the application will start to sleep. The entire core will be dedicated to busy threads from other domains. When the application becomes busy, that is, one or more threads in host domain become busy, then the sleeping threads of the application will be activated, and threads from guest domains will be migrated to other cores available for execution.

On the other hand, if the application determines to share the pre-assigned core's resources, the application can mark the decision flag accordingly. In such instances, the threads of the application will do nothing and do not need to sleep. Instead, the threads can co-run on the same core with busy threads of other domains and share time slices. When the application becomes busy, the threads of another application executing on the pre-assigned core will be migrated to another core, ceding the resources of the pre-assigned core to the host domain. In sum, donation of a core means that the core is dedicated to a different busy domain while the application that dedicated to the core sleeps. Sharing means that the application holds the core but will share the core with other threads until the application needs the threads back.

The techniques described here can be implemented by each core. That is, each core can maintain a bitmap, provide the bitmap to a global memory location, and implement self-balancing by referencing the bitmap table maintained at the global memory location. In addition, operating system (OS) running on each core can implement self-balancing by referencing the bitmap table. Alternatively, the techniques described here can be implemented by a controller connected to the multiple cores in the machine. For example, the controller can receive bitmaps from the multiple cores, maintain the bitmap table at the global memory location, and implement elastic load balancing by referencing the bitmap table.

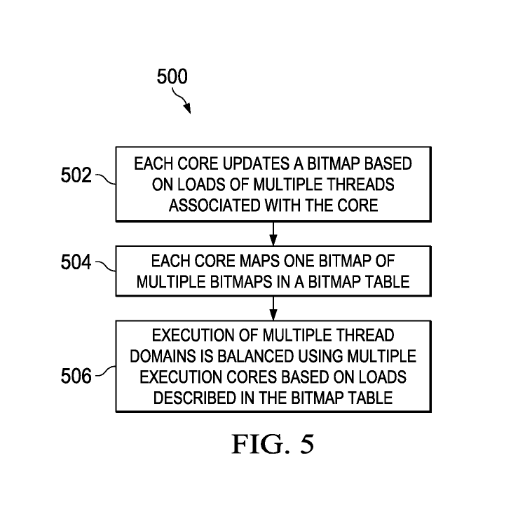

FIG. 5 is a flowchart of an example of a process 500 for elastically load balancing threads executable on the machine of FIG. 1. The process 500 can be implemented either by each core in a machine or a controller connected to multiple cores in the machine or both. At 502, each core updates a bitmap based on loads of a plurality of threads, the plurality of threads associated with the core.

At 504, each core maps the bitmap of a plurality of bitmaps in a bitmap table. The bitmap table can be maintained in a global memory location which is accessible by multiple thread domains configured to execute threads using the multiple thread execution cores. Each bitmap indicates loads of multiple threads included in a thread domain. The multiple threads are associated with and are to be executed using each core. Each core maintains and updates the respective bitmap based on loads of the multiple threads.

At 506, execution of multiple thread domains is balanced using the multiple execution cores based on loads described in the bitmap table.

Implementations of the subject matter and the operations described in this specification can be implemented as a controller including digital electronic circuitry, or computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a controller on data stored on one or more computer-readable storage devices or received from other sources.

The controller can include one or more data processing apparatuses to perform the operations described here. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Thus, particular implementations of the subject matter have been described. Other implementations are within the scope of the following claims.

1. A method of balancing load on a plurality of thread execution cores, the method comprising:
updating a plurality of bitmaps, wherein each of the plurality of bitmaps indicates loads of a plurality of threads, the plurality of threads associated with each of the plurality of thread execution cores;
maintaining the plurality of bitmaps in a global memory location which is accessible by the plurality of threads associated with each of the plurality of thread execution cores; and
balancing loads of the plurality of threads associated with each of the plurality of thread execution cores based on the plurality of bitmaps in the global memory location.

2. The method of claim 1, wherein the plurality of thread execution cores comprises a first thread execution core, wherein a bitmap associated with the first thread execution core comprises a table of rows, a row other than a first row in the table indicates if a first thread of a first plurality of threads associated with the first thread execution core is busy.

3. The method of claim 2, wherein the first row in the table of rows indicates if a thread domain has been assigned to the first thread execution core, the assigned thread domain comprising the first thread.

4. The method of claim 3, wherein a value stored in the first row is set to 1 when a thread domain has been assigned to the first thread execution core or is set to 0 when a thread domain has not been assigned to the first thread execution core.

5. The method of claim 2, wherein a value in the row other than the first row is set to 1 if the first thread is busy or is set to 0 if the first thread is available.

6. The method of claim 5, wherein the value in the row other than the first row is changed from 1 to 0 if the first thread becomes available.

7. The method of claim 1, wherein balancing loads of the plurality of threads associated with each of the plurality of thread execution cores based on the plurality of bitmaps in the global memory location comprises:
determining that a first thread associated with a first thread execution core is busy;
identifying a second thread execution core that is available based on scanning a second bitmap of the plurality of bitmaps in the global memory location; and
transferring at least a portion of the first thread to the second thread execution core.

8. The method of claim 7, wherein the second bitmap includes a plurality of rows, wherein a value in each row is set to 0 in response to a thread executable by the second thread execution core being available to execute a thread or set to 1 in response to the thread executable by the second thread execution core being busy, and wherein identifying the second thread execution core comprises:
performing a Boolean OR operation on the plurality of rows, wherein a result of the Boolean OR operation is 0 in response to the second thread execution core is available to execute a thread or 1 in response to the second thread execution core being busy.

9. The method of claim 7, wherein a second thread domain including a second thread is assigned to the second execution core resulting in the second thread having a higher precedence to be executed by the second execution core compared to other threads, and wherein the method further comprising:
at a time after transferring at least a portion of the first thread to the second thread execution core, determining that the second execution core is busy; and
transferring the execution of the first thread away from the second thread execution core in response to determining that the second execution core is busy.

10. The method of claim 9, wherein the second bitmap includes a plurality of rows including a first row and remaining rows, wherein a value stored in the first row is set to 1 when a thread domain has been assigned to the second thread execution core and is set to 0 when no thread domain has been assigned to the second execution core, wherein a value in each remaining row is set to 0 in response to a thread executable by the second thread execution core being available to execute a thread or set to 1 in response to the thread executable by the second thread execution core being busy, and wherein determining that the second thread execution core is busy comprises:
performing a Boolean OR operation on the remaining rows; and
performing a Boolean AND operation on a result of performing the Boolean OR operation on the remaining rows with the first row.

11. The method of claim 1, wherein a third thread domain assigned to a third thread execution core comprises a subset of a plurality of threads, the subset associated with the third thread execution core, and wherein the method further comprises:
setting the third thread domain to donate the third thread execution core to execute threads associated with other thread domains; and
in response to setting the third thread domain to donate the third thread execution core to execute threads associated with other thread domains, setting active threads associated with the third thread domain to sleep.

12. The method of claim 1, wherein a fourth thread domain assigned to a fourth thread execution core, the fourth thread domain comprising a subset of a plurality of threads, the subset associated with the fourth thread execution core, and wherein the method further comprises:
setting the fourth thread domain to share the fourth thread execution core to execute threads associated with other thread domains; and
in response to setting the fourth thread domain to share the fourth thread execution core to execute threads associated with other thread domains:
setting a subset of active threads associated with the fourth thread domain to be available to another thread domain,
executing at least a portion of the subset of active threads using the fourth thread execution core, and
in response to the other thread domain needing threads for execution, migrating the subset of active threads to the other thread domain.

13. The method of claim 12, wherein the subset of active threads associated with the fourth thread domain are used to execute threads associated with another thread domain, further comprising:
determining that a load on the fourth thread domain exceeds a threshold load;
in response to determining that the load on the fourth thread domain exceeds the threshold load, migrating execution on the subset of active threads associated with the fourth thread domain to a different core within a determined duration; and
after the determined duration has expired, ceding the subset of active threads associated with the fourth thread domain to the fourth thread execution core.

14. The method of claim 1, wherein balancing loads of the plurality of threads associated with each of the plurality of thread execution cores based on the plurality of bitmaps in the global memory location comprises balancing loads based on flags maintained in the plurality of thread execution cores, each flag indicating whether resources of each thread execution core are available for donation or sharing, and wherein the method further comprises, for a first thread execution core:
determining that a first flag in a first bitmap maintained by the first thread execution core is set to indicate that resources of the first thread execution core are available for donation; and
setting threads pre-assigned to the first thread execution core to sleep in response to determining that the first flag is set to indicate that the resources are available for donation.

15. A thread execution core to self-balance load, the thread execution core configured to perform operations comprising:
updating a bitmap based on loads of a plurality of threads, the plurality of threads associated with the thread execution core;
maintaining the bitmap of a plurality of bitmaps in a global memory location, wherein the global memory location is accessible by the plurality of threads associated with the thread execution core, and wherein each of the plurality of bitmaps indicates loads of a plurality of threads associated with each of a plurality of thread execution cores; and
balancing loads of the plurality of threads associated with the thread execution core based on the plurality of bitmaps in the global memory location.

16. The core of claim 12, wherein the bitmap maintained by the thread execution core comprises a table of rows, a row other than a first row in the table indicates if a first thread of the plurality of threads associated with the thread execution core is busy,

17. The core of claim 16, wherein the first row in the table of rows indicates if a thread domain has been assigned to the thread execution core, the assigned thread domain comprising the first thread, wherein a value stored in the first row is set to 1 when a thread domain has been assigned to the thread execution core or is set to 0 when a thread domain has not been assigned to the thread execution core.

18. The core of claim 17, wherein a value in the row other than the first row is set to 1 if the first thread is busy or is set to 0 if the first thread is available, and wherein the value in the row other than the first row is changed from 1 to 0 if the first thread becomes available.

19. The core of claim 15, wherein balancing loads of the plurality of threads associated with the thread execution core based on the plurality of bitmaps in the global memory location comprises balancing loads of the plurality of threads based on flags maintained in the plurality of thread execution cores, each flag indicating whether resources of each thread execution core are available for donation or sharing.

20. A system to balance load on a plurality of thread execution cores, the system comprising:
a global memory location which is accessible by a plurality of thread domains configured to execute threads using the plurality of thread execution cores; and
a thread execution core of the plurality of thread execution cores, the thread execution core coupled to the global memory location, the thread execution core configured to perform operations comprising:
updating a bitmap based on loads of a plurality of threads, the plurality of threads associated with the thread execution core;
maintaining the bitmap of a plurality of bitmaps in the global memory location, wherein each of the plurality of bitmaps indicates loads of a plurality of threads associated with each of the plurality of thread execution cores; and
balancing execution of the plurality of threads associated with the thread execution core based on the plurality of bitmaps in the global memory location.
